(19) United States
(12) Patent Application Publication
(10) Pub. No.: US 2024/0076445 A1
(43) Pub. Date: Mar. 7, 2024

(54) Method for Making Polymers by Transesterification of Polyols and Alkyl Esters of Polycarboxylic Acids, Polymers and Copolymers Made Thereby and Polymeric and Copolymeric Articles

(71) Applicant: Maguire Abbey, LLC, Wilmington, DE (US)

(72) Inventors: Michael P. Greuel, Solon, OH (US); Joseph P. Laico, Longboat Key, FL (US)

(21) Appl. No.: 18/320,915

(22) Filed: May 19, 2023

Related U.S. Application Data
(63) Continuation of application No. 17/342,524, filed on Jun. 8, 2021, now abandoned.
(60) Provisional application No. 63/036,437, filed on Jun. 8, 2020.

(51) Int. Cl. C08G 63/46; C08G 63/82; C08G 63/91

(52) U.S. Cl. CPC C08G 63/46; C08G 63/82; C08G 63/914; C08G 63/80

(57) ABSTRACT

The method is described herein for forming a polymer, comprising providing a first monomer comprising a polyol having at least two hydroxyl groups; providing a second monomer comprising a polyalkyl ester of a polycarboxylic acid having at least two alkyl ester groups; mixing the first monomer and the second monomer to form a reaction mixture; and reacting the first monomer and the second monomer in the mixture by transesterification to form a polyester polymer, which may, if desired be crosslinked. The polymers may also be copolymerized with other monomers. Polymers and copolymers formed from the method herein, as well as articles formed therefrom are also described. Such polymers and articles may be biocompatible and/or bioresorbable.

### CROSS-REFERENCE TO RELATED APPLICATIONS

This Non-Provisional Patent Application is a continuation patent application under U.S.C. § 120 of U.S. Non-Provisional Patent Application No. 17/342,524, filed Jun. 8, 2021, entitled “Method for Making Polymers by Transesterification of Polyols and Alkyl Esters of Polycarboxylic Acids, Polymers and Copolymers Made Thereby and Polymeric and Copolymeric Articles,” and which claims the benefit under 35 U.S.C. § 119(e) to U.S. Provisional Patent Application No. 63/036,437, filed Jun. 8, 2020, entitled, “Method for Making Polymers by Transesterification of Polyols and Alkyl Esters of Polycarboxylic Acids, Polymers and Copolymers Made Thereby and Polymeric and Copolymeric Articles,” the entire disclosures of which are incorporated herein by reference.

### BACKGROUND OF THE INVENTION

### Field of the Invention

The invention is directed to a new process for preparing polymers from the reaction of polyols and alkyl esters of polycarboxylic acids, and for making copolymers with such polymers, and more specifically for making biocompatible and bioresorbable polymers and copolymers by a method including the transesterification reaction of organic diols or triols with alkyl esters of polycarboxylic acids, and the resulting polymers and copolymers.

### Description of Related Art

Biocompatible and bioresorbable polymers are known in the art and have many uses. The applicant herein previously developed a treatment for treating patients with arthritic joints adopting use of such polymers. As noted in applicant's U.S. Pat. No. 9,186,377, U.S. Patent Application Publication No. US 2016/0030468 A1 and International Patent Publication No. WO 2019/050975 A1, such materials can be formed to create particles (beads) for treatment in mammal joints.

Joints, such as synovial joints, for example, hip, knee, shoulder and ankle joints are surrounded by an envelope or synovial capsule. The inner layer of the synovial capsule is called a synovial membrane which produces synovial fluid. The fluid is partially stored within the joint cartilage and the remaining fluid circulates freely within the synovial capsule. The capsule maintains the fluid within the joint. In a hip joint, a ring of soft tissue called the acetabular labrum aids in maintaining the fluid in the femoral-acetabular interface. The fluid lubricates and thus reduces friction inside of the joint. In ball and socket synovial joints, the fluid lubricates the ball and socket interface, particularly during movement. For example, the wringing action of the synovial capsule in a hip joint, particularly during flexion and extension movement of the joint, and the paddling action of the femoral neck combine to pump synovial fluid into and across the femoral-acetabular interface thus lubricating the joint. The synovial fluid also cushions the joints during movement, provides oxygen and nutrients to the joint cartilage and removes carbon dioxide and metabolic waste.

Synovial fluid is generally composed of hyaluronic acid, lubricin, proteinases, and collagenases. The hyaluronic acid imparts anti-inflammatory and pain-reducing properties to the normal synovial fluid and contributes to joint lubrication and cushioning during movement. Synovial fluid also exhibits non-Newtonian flow characteristics and thixotropy where the fluid viscosity decreases over time under stress due to movement.

A lack of synovial fluid within the joint, particularly within the ball and socket interface, can aggravate arthritic conditions. Osteoarthritis, the wear and tear of aging, and other injuries or ailments can cause irregularity of the joint surface. In a hip joint, osteoarthritis can also cause fraying of the acetabular labrum resulting in the loss of its gasket-like sealing property. The fraying of the labrum allows migration of the synovial fluid away from the femoral-acetabular interface. Gravity also acts on vertical synovial joints such as hip joints by drawing the synovial fluid downward and away from the femoral-acetabular interface. Moreover, the stress and/or inflammation in synovial joints over time reduce the viscosity of the fluid, making it a less effective lubricant and more difficult for the fluid to effectively coat the joint interface. This reduction in synovial fluid flow in the joint interface often results in further reduction in the sealing capacity of the labrum and roughening or incongruity of the joint interface causing increased pain and stiffness in the joint. The pain and stiffness cause a decrease in the motion of the joint resulting in a loss of the pumping action and decrease in the flow of the synovial fluid in the joint interface. This can eventually lead to joint replacement surgery.

To address this problem, artificial lubricants were developed to replace and/or supplement the lubricating and cushioning action of the synovial fluid in the joint. These lubricants are generally referred to as viscosupplements and generally include hyaluronic acid. However, the degradation of the acetabular labrum associated with osteoarthritis can result in leakage and decreased flow of the viscosupplements. Thus, multiple viscosupplement treatments can be required.

Other treatments to address this issue include joint replacement surgery, arthroscopic surgery, medication and physical therapy. Joint replacement surgery includes replacement of the joint with a prosthetic implant. The prosthetic implant may be constructed of various materials including metal and polymer materials. In addition, the typical health risks associated with major joint surgery in older patients, risks and complications of the procedure include infection, dislocation, loosening, or impingement of the implant. In hip replacement surgery, the risks also include fractures of the femur. Moreover, the implant may wear over time causing dissemination of metal and polymer debris within the joint and body, in general.

The Applicant herein addressed such issues in the prior art in the above noted patents by using biocompatible, resorbable polymers and copolymers to form particles sufficient to operate to increase fluid movement within a joint. The particles preferably have a Young's Modulus and Poisson's ratio as well as an average density that allow them to function along with synovial fluid or other lubricant additives to push and move fluid through the joint space.

Polymers identified in embodiments for use in making such particles, and that are known for other medical and FDA-approved uses, include various biocompatible and bioresorbable polymers including poly(alpha-hydroxy acid) polymers, such as poly(glycolic acid) (PGA), copolymers of lactic acid and glycolic acid (PLGA), polyoxalates, polycaprolactone (PCL), copolymers of caprolactone and lactic acid (PCLA), poly(ether ester) multiblock copolymers based on polyethylene glycol and poly(butylene terephthalate), tyrosine-derived polycarbonates, poly(hydroxybutyrate), poly(alkylcarbonate), poly(orthoesters), polyesters, poly(hydroxyvaleric acid), poly(malic acid), poly(tartaric acid), poly(acrylamides), polyanhydrides, and polyphosphazenes. Such polymers may also be combined into blends, alloys or copolymerized with one another and also functionalized.

Certain of such biocompatible and/or resorbable polymeric and/or elastomer materials, which may or may not be modified for lubrication, were identified by the applicant herein as enhancing the beneficial effects of applicant's medical treatment in the applicant's patent filings as noted above when used for forming the particles of that medical treatment, including copolymers of polyols and carboxylic acids formed by esterification, such as poly(glycerol sebacate) (PGS), poly(glycerol sebacate)-co-poly(lactic acid) and copolymers and derivatives of the such polymers.

Preparing such polymer and copolymer materials, however, can be expensive and it can also be difficult to obtain high-yields with consistency using processes currently available. Poly(glycerol sebacate) was initially formed according to a process described in U.S. Pat. No. 7,722,894 via esterification of a polyol and a carboxylic acid. In a such a polyesterification reaction, polycondensation of the monomers occurs to form the polymer. The polyol and carboxylic acid molecules react to form an ester and a molecule of water and the process continues to form the polymer with water as a byproduct of the process. The water must be removed from the reaction mixture in order to push the equilibrium to the higher conversion necessary to synthesize a polymer with sufficient molecular weight to be useful. The resulting poly(glycerol sebacate) is a cross-linked polyester with elastomeric properties.

Sebacic acid is a crystalline solid with a melting point of 133-137° C. It is not highly soluble in glycerol under the polymerization conditions employed in this process. As a result, the sebacic acid slowly dissolves while the polymerization reaction is occurring, such that a significant amount of conversion occurs before the reaction mixture become homogeneous, which tends to result in polymeric products having broad molecular weight distributions. This is problematic both in terms of yield and in attempting to achieve consistent properties.

U.S. Pat. No. 9,359,472 teaches a method attempting to resolve the issues associated with the method of U.S. Pat. No. 7,772,894 by developing a water-mediated polymerization that was directed to resolving the solubility issue. In the process, water is introduced to the polymerization at the beginning and the mixture is subsequently refluxed until it is asserted to be homogeneous, at which point the water is distilled off and the polymerization continues to produce a polymeric product that is described in the '472 patent as having a narrower molecular weight distribution than that of the process of U.S. Pat. No. 7,772,894. The water mediated polymerization, however, also has drawbacks, as does that of the 7,772,894 patent, related to the time and energy required to remove water from the reaction mixture to achieve adequate conversion. In addition to long reaction times, the prior art processes also employ high vacuum conditions to adequately remove water from the reaction vessel. This requires equipment that is capable of providing a high vacuum and an associated high energy usage.

Other attempts in the art to provide improvements to formation of poly(glycerol sebacate) synthesis involve introducing co-monomers to the process such as polyethylene glycol (PEG) to control hydrophilicity and degradation rates. See, e.g., A. Patel et al., “Highly Elastomeric Poly(Glycerol Sebacate)-co-Poly(Ethylene Glycol) Amphiphilic Block Copolymers,” Biomaterials, vol. 34(16), pp. 3970-3953 (May 2013). Incorporation of acrylate and UV radiation curing in the presence of a photoinitiator was introduced to speed-up reaction time and reduce curing time through radiation curing to form copolymers of poly(glycerol sebacate) acrylate (PGSA). See, R. Rai et al., “Synthesis, Properties and Biomedical Applications of Poly(Glycerol Sebacate)(PGS): A Review,” Progress in Polymer Science, vol. 37, pp. 1051-1078 (2012).

There is still a need in the art to economically produce consistent polymers and copolymers of biocompatible and/or bioresorbable materials such as poly(glycerol sebacate), which may be employed in various medical and other uses, and which can also be adopted for use in and as a further improvement of applicant's patented method of treating arthritis.

### BRIEF SUMMARY OF THE INVENTION

The invention herein includes a method for forming a polymer, comprising: providing a first monomer comprising a polyol having at least two hydroxyl groups; providing a second monomer comprising a polyalkyl ester of a polycarboxylic acid having at least two alkyl ester groups; mixing the first monomer and the second monomer to form a reaction mixture; and reacting the first monomer and the second monomer in the mixture by transesterification to form a polyester polymer.

In preferred embodiments of the method herein, the first monomer comprises a diol or a triol, and preferably a polyol with at least three hydroxyl groups. In preferred embodiments, the first monomer is a triol. For example, the first monomer may be selected from the group consisting of glycerol, pentaerythritol, and xylitol, and in preferred embodiments, the first monomer is glycerol.

In preferred embodiments herein, the second monomer may be a dialkyl ester of a dicarboxylic acid of from 2 to about 30 carbon atoms. The second monomer may be a dialkyl ester of a dicarboxylic acid that is one or more of oxalic acid, malonic acid, succinic acid, glutaric acid, adipic acid, pimelic acid, suberic acid, azelaic acid, sebacic acid, undecanedioic acid, dodecanedioic acid, brassylic acid, thapsic acid, japanic acid, phellogenic acid, and equisetolic acid.

In one preferred embodiment, the first monomer is glycerol and the second monomer is dimethyl sebacate, and the polymer is poly(glycerol sebacate).

The molar ratio of the first monomer to the second monomer for use in the reaction mixture may be about 0.5:1 to about 1:0.5, preferably about 0.75:1 to about 1:0.75, and most preferably about 1:1.

The transesterification reaction preferably occurs at a temperature wherein the first and the second monomers are liquids, to facilitate intimate mixing of the first monomer and the second monomer during the transesterification reaction.

In a preferred embodiment herein, the reaction mixture further includes a transesterification reaction catalyst selected from an acid catalyst, a base catalyst, an alkyl titanate catalyst or an alkyl tin catalyst, such as a dibutyl tin oxide.

The transesterification reaction generally forms a byproduct that is volatile, such as an alkanol.

In one embodiment, the viscosity and hydroxyl value of the reaction mixture of the first monomer and the second monomer may be monitored to determine the progress of the transesterification reaction.

The transesterification reaction may be terminated as a prepolymer, and the method may further comprise post-curing or further polymerizing the prepolymer through a heat process or through further forming a polymer such as a crosslinked polyester polymer, as well as optionally further comprising post-curing the polymer and/or further reaction of the prepolymer with a crosslinking agent(s), e.g., with one or more polyisocyanates.

In the method, the reaction mixture may be formed before onset of the reaction, or alternatively, may be formed at least partially simultaneously with the onset of the reaction.

The polymer formed is preferably crosslinked and has elastomeric properties.

The polymer is preferably also biocompatible and/or bioresorbable.

The invention also includes polymers, such as crosslinked polyester polymers, formed by the method herein and as noted above. The polymer may be poly(glycerol sebacate) in preferred embodiments herein.

Also within the invention is an article formed from a polymer made by the method herein and as noted above. The article is preferably biocompatible and/or bioresorbable.

The article may be for example, one or more of a polymer sheet, a drug delivery device, a mammalian tissue adhesive, a soft tissue replacement, a hard tissue replacement, a tissue engineering lattice, a medical device or a component thereof, and a particle for treatment of a mammalian joint. In a preferred embodiment, the article is formed as a particle (bead) for use in treating an arthritic mammalian joint.

The method herein may further comprise introducing at least one co-monomer for forming a copolymer as described herein.

In such a method, the at least one comonomer may comprise one or more monomers, for example, comonomers such as a polyol or alkylene polyol, each being different from the polyol of the first monomer; a cyclic ester; an acrylate; a methacrylate; an alkyl acrylate; an alkyl methacrylate; a carboxylic acid; a polycarboxylic acid; an alkyl polyiisocyanate; and an ester of a polycarboxylic acid that is different than the second monomer.

The method may also then include introducing the comonomer so that it is provided in amounts that are in some embodiments not greater than about 30 mole % of the overall total moles of the monomers in the reaction mixture, or not greater than about 10 mole % of the overall total moles of the monomers in the reaction mixture. Such a method may also further comprise introducing the comonomer after the reaction between the first and second monomer has begun. In one preferred embodiment, the first monomer is glycerol, the second monomer is dimethyl sebacate and the comonomer is selected from the group of polylactic acid, caprolactone, ethylene glycol, propylene glycol, polypropylene glycol, polyethylene glycol, glycolic acid, hexamethylene diisocyanate, and methylene diisocyanate.

The invention further includes a copolymer formed from the method noted above having one or more additional co-monomers. The copolymer in one embodiment may be a poly(glycerol sebacate)-co-poly(lactic acid). The invention may also include articles formed from the copolymer, which in preferred embodiments are biocompatible and/or bioresorbable. Such articles may be selected from a polymer sheet, a drug delivery device, a mammalian tissue adhesive, a soft tissue replacement, a hard tissue replacement, a tissue engineering lattice, a medical device or a component thereof, and a particle for treatment of a mammalian joint, and preferably include particles for treatment of arthritic mammalian joints.

### BRIEF DESCRIPTION OF THE SEVERAL VIEWS OF THE DRAWING(S)

The foregoing summary, as well as the following detailed description of preferred embodiments of the invention, will be better understood when read in conjunction with the appended drawings. For the purpose of illustrating the invention, there is shown in the drawings embodiments which are presently preferred. It should be understood, however, that the invention is not limited to the precise arrangements and instrumentalities shown. In the drawings:

FIG. 1 is a plot of Fourier transform infrared spectroscopy (FTIR) spectra taken over the course of the reaction carried out in Example 1.

FIG. 2 is a plot of viscosity versus hydroxyl value prepared in accordance with the process herein as carried out in Example 1.

FIG. 3 is a gel permeation chromatography (GPC) chromatogram of the PGS product of Example 2.

FIG. 4 is a plot of FTIR spectra taken of an uncured PGS prepolymer and a thermally cured PGS elastomer.

FIG. 5 is a plot of FTIR spectra taken of an uncured PGS prepolymer and isocyanate cured PGS elastomers.

### DETAILED DESCRIPTION OF THE INVENTION

The resorbable, biodegradable particles used in the invention of U.S. Pat. No. 9,186,377 and International Patent Publication No. WO 2019/050975 A1 increase the lubrication within a joint when introduced into the intra-articular space of the joint compared to synovial fluid, viscosupplemental fluid, or combinations thereof. The increase in fluid movement results in improved lubrication of the joint thus providing treatment of osteoarthritis and improved lubrication of prosthetic implants. Such particles are preferably constructed from materials that preferably have a Tg within the joint of less than the normal body temperature of about 37° C. so that the particles are soft enough to prevent impingement within the joint interface. The fluid within the joint may have a plasticizing effect on the particles and thus reduce their Tg in vivo. Accordingly, particles with a Tg outside of the body greater than 37° C. may still be suitable in such a method of treatment.

Such particles are sized so that they can effectively increase the fluid movement within the joint while limiting impingement in the joint interface. The average particle size of such particles is about 0.5 millimeters to about 5 millimeters. The particles are preferably uniformly sized while significant particle size variations can also acceptable. The particle size may vary depending on the size of the device used to introduce the particles into the joint, the mass required to increase fluid motion within the joint, and volume of the joint space.

The physical parameters that affect the ability of the particles to increase fluid movement within a joint include, but are not limited to, Young's Modulus, Poisson's ratio, and average density. The Young's Modulus of the particles is the ratio of the stress, which has units of pressure, to strain, which is dimensionless. In one embodiment, the Young's Modulus may be about 0.5 to about 500 megapascals, and more preferably about 0.5 to about 100 megapascals and most preferably about 0.5 to about 30 megapascals.

The Poisson's ratio of the particles is another parameter that affects the ability of the particles to increase the fluid movement within a joint. Poisson's ratio is the ratio, when a sample is stretched, of the contraction or transverse strain (perpendicular to the applied load), to the extension or axial strain (in the direction of the applied load). The Poisson's ratio of the particles is preferably about 0.1 to about 0.5. The Poisson's ratio is most preferably about 0.3.

The average density of the particles also contributes to the effectiveness of the particles in increasing fluid movement within the joint. The average density is preferably greater than the density of the fluid within the joint to reduce impingement in the joint interface. An average particle density greater that the density of the joint fluid also allows the particles to be positioned below the level of the joint fluid and thus “push” the fluid across the joint interface during joint motion. For example, the wringing action of the synovial capsule and upward stirring effect of the elliptically-shaped femoral neck facilitates this “pushing” action in a hip joint. The density of synovial fluid is typically about 1.015 g/ml. Accordingly, the average density of the particles is preferably greater than about 1.015 g/ml. The maximum density of the particles is preferably about 2.5 g/ml. The average density is most preferably about 1.2 g/ml.

The particles are preferably formed of at least one resorbable, biocompatible material(s) that is/are preferably commercially available and FDA-approved for use in the body of a mammal. As used herein, a resorbable material is defined as a material readily degraded in the body and subsequently disposed of by the body or absorbed into the body tissue. As used herein, a biocompatible material is one that is not toxic to the body and does not cause tissue inflammation. The particles made for use in the treatment are preferably able to resorb within the joint in about 3 to about 12 months, although the rate of resorbance will depend to some extent on the material chosen. The particles most preferably resorb in about 3 to about 6 months. As used herein, “mammal” encompasses humans and animals.

The resorbable, biocompatible particles may be formed of natural or synthetic materials as described in 9,186,377 and International Patent Publication No. WO 2019/050975 A1. When the particles are those traditionally formed of a polymer prepared by esterification of polyols and carboxylic acids, such as poly(glycerol sebacate) (PGS), poly(glycerol sebacate lactic acid) (PGSL), and other copolymers and derivatives of these and similar polymer materials, such polymers while useful, are preferably instead made according to the method herein.

Such polymers and copolymers formed by the method herein may be randomly formed, or may prepared and/or altered to form block, or grafted polymers through copolymerization. Varying degrees of copolymerization and/or crosslinking of the polymers and copolymers of the present method may also be carried out for developing polymers with differing degrees of mechanical, elastomeric and/or degradation properties. Polymers made according to the method may also be combined into blends, alloys and/or copolymerized or crosslinked with each other and/or with other similar polymers such as those noted in the background section herein as useful in applicant's medical treatment according to U.S. Pat. No. 9,186,377 and WO2019/050974 A1 and for use in other biomedical, pharmaceutical or mechanical applications.

The preferred process herein may be used to form polymers from polyols and alkylesters of polycarboxylic acids, and to further make copolymers of such polymers. The resulting polymers in preferred embodiments herein are preferably crosslinked polyester polymers that can be elastomeric and/or polymers demonstrating elastomeric properties and/or behavior through crosslinking, and are suitable for use in the method of treatment of U.S. Pat. No. 9,186,377, U.S and International Patent Publication No. WO 2019/050975 A1 as well as other medical and industrial uses and in other end applications for which poly(glycerol sebacate) polymers and copolymers are used.

Functional groups for specific properties (e.g., pH adjustment, or adjustment to physical properties or for crosslinking or surface modification) may be provided. Examples include, but are not limited to, alkyl, aryl, fluoro, chloro, bromo, iodo, hydroxyl, carbonyl, aldehyde, haloformyl, carbonate ester, carboxylate, carboxyl, ether, ester, hydroperoxy, peroxy, carboxamide, amine, ketimine, aldimine, imide, azide, diimide, cyanate, isocyanate, nitrate, nitrile, nitrosooxy, nitro, nitroso, pydridyl, sulfonyl, sulfo, sulfinyl, sulfino, sulfhydryl, thiocyanate, disulfide, phosphino, phosphono, phosphate groups, and combinations thereof. Preferred functional groups include carboxyl, alkyl ester, alkyl ether and hydroxyl groups. The more preferred functional groups include carboxyl and alkyl ester groups.

Resorbable, biocompatible, polyester-based elastomers which are prepared using polyols and carboxylic acids, copolymers and elastomers as noted above, such as PGS and PGSL and similar polymers can yield particles with enhanced properties as elastomeric materials due to a crosslinked structure. One improvement is in the form of enhanced recovery in response to deformation, which allows the particle to retain the desired shape more effectively. A second improvement is in the form of enhanced retention of physical properties over the lifetime of the particle, in vivo. Further, particles such as those formed from PGS and its copolymers tend to erode from the outside in, rather than bulk erode, which means that the particles get smaller as they degrade, but retain their physical properties much longer than materials that degrade more homogenously throughout the bulk of the particle.

The particles may be formed of any shape including, but not limited to spherical, oval, elliptical, cylindrical, cuboidal, pyramidal, or cruciform. However, the particles are preferably spherical to minimize impingement in the joint interface.

The polymers for use in making the particles are preferably formed according to the method of the invention herein. The method used herein includes a transesterification reaction of one or more polyols, preferably diols or triols, with at least one alkyl ester of a polycarboxylic acid to form a polyester polymer, which in preferred embodiments herein has polyester structures therein as well as crosslinking initiated through use of triol monomers.

As used herein, “polyol” with respect to the monomers herein means a compound having at least two hydroxyl groups. A “diol” means a polyol having two hydroxyl groups. A “triol” means a polyol having three hydroxyl groups. As used herein “polycarboxylic acid” with respect to the monomers herein means a carboxylic acid having at least two carboxylic acid groups. A “dicarboxylic acid” is intended to mean a carboxylic acid with two carboxylic acid groups.

As used herein, an alkyl ester of a polycarboxylic acid preferably has at least two alkyl ester groups on an organic acid backbone of the following structure (I):

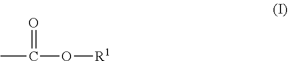

Preferably at least two of such groups are terminal alkyl ester carboxylate groups forming a dicarboxylic acid base molecule of the following structure (II):

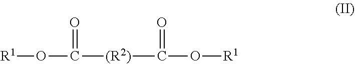

In formulae (I) and (II), R¹ is preferably selected from a groups including an alkyl, alkenyl or alkynyl group of from 1 to about four carbon atoms, such as methyl, ethyl, propyl, isopropyl, isobutyl, t-butyl. The group should remain capable as acting as a chain extending group and/or a crosslinking group for the purpose of reacting with a polyol in a transesterification reaction to form a polymer. Each R¹ group may be the same or different and is preferably from about 1 to about 3 carbon atoms, including methyl, ethyl, propyl and isopropyl groups.

In the above-formula (II), R² may be either a covalent bond between the two carbon atoms on either side of R² for forming a dialkyl ester of oxalic acid (HOOC—COOH) also known as ethanedioic acid, or may be a straight chain or a branched chain of from 1 to about 30 carbon atoms, and more preferably from 1 to about twenty carbon atoms, which may be incorporated into the molecule such that, in preferred embodiments, it is preferably a straight chain hydrocarbyl group which the R(C═O)OH groups on either end forms a dialkyl ester of a dicarboxylic acid such as the following dicarboxylic acids: malonic acid (propanedioic acid), succinic acid (butanedioic acid), glutaric acid (pentanedioic acid), adipic acid (hexanedioic acid), pimelic acid (heptanedioic acid), suberic acid (octanedioic acid), azelaic acid (nonanedioic acid), sebacic acid (decanedioic acid), undecanedioic acid, dodecanedioic acid, brassylic acid (tridecanedioic acid), thapsic acid (hexadecanedioic acid), japanic acid (heneicosa-1,21-dioic acid), phellogenic acid (docosanedioic acid), equisetolic acid (triacontanedioic acid) and other similar structures. It is also acceptable to use trifunctional or higher functional polycarboxylic acids, including trimellitic acid, citric acid, isocitric acid, aconitic acid, trimesic acid and the like. In the case of trifunctional or polyfunctional polycarboxylic acids, the acid groups may be modified to be alkyl ester groups either on all or at least two of the acid groups.

The R² groups may also be branched or functionalized to include varying groups, either attached to the chain, for example, for developing special properties and/or for crosslinking such as one or more of alkyl, aryl, halogens such as fluoro, chloro, bromo, iodo, hydroxyl, carbonyl, further alkyl carboxylic acid ester groups, aldehydes, haloformyl, carbonate ester, carboxylate, carboxyl, ethers, esters, hydroperoxy, peroxy, carboxamide, amine, ketimine, aldimine, imide, azide, diimide, cyanate, isocyanate, nitrate, nitrile, nitrosooxy, nitro, nitroso, pydridyl, sulfonyl, sulfo, sulfinyl, sulfino, sulfhydryl, thiocyanate, disulfide, phosphino, phosphono, phosphate groups, and combinations thereof or incorporated into the chain such as an ether, sulfur, nitrogen atoms, or aryl groups and the like. Preferred functional groups include carboxyl, alkyl ester, alkyl ether and hydroxyl groups. The more preferred functional groups include carboxyl and alkyl ester groups.

Polyols for use herein as monomers may be any polyol having two or more hydroxyl groups, such as ethylene glycol, propylene glycol, 1,6 hexane diol, 1,4-butane diol, neopentyl glycol, and similar materials. Preferably the polyols have at least three hydroxyl groups for providing sufficient reactive OH groups to the transesterification reaction for linking the polymer by reaction of the alkyl ester groups on the dialkyl esters of carboxylic acids as noted above. The main carbon chain in the polyols can be monomeric and about one to about 30 carbon atoms, and preferably less than 20 carbon atoms, and the primary carbon chain may be a straight or branched chain structure. The preferred polyols are those that will form a biocompatible, and preferably bioresorbable end product, and including a hydrocarbyl chain functionalized with three or more hydroxyl groups. Particularly preferred are glycerol, pentaerythritol, xylitol, trimethylol propane, trimethylol, ethane, or, polyether polyols and polyester polyols, preferably of a monomeric, oligomeric or shorter chain polymeric structure, with molecular weights of 5,000 of less, however, such materials may be varied provided that they are able to form the preferred biocompatible materials as noted above using the reactions steps as noted herein.

In formation of the polyester polymers herein, the process is typically stopped before reaching the gel point, and then can be formed into an article through various means at which time, the article can continue to be formed, reacted with other co-monomers or thermally treated if heat is required to finalize the formation of the polyester polymer, including completing any desired crosslinking. However, at the point of forming and also in finally formed articles there are the presence excess hydroxyl and/or ester groups which can be used for later bonding with co-monomers, for surface treatments and coatings and the like. The degree of free reactive groups will depend on the desired degree of crosslinking.

In one embodiment, the polymerization process is stopped prior to the gel point and the resulting polyester polymer is subsequently crosslinked by reacting excess hydroxyl and/or ester groups with a crosslinking agent to form an elastomer. In a preferred embodiment, the polyester polymer is crosslinked by reacting excess hydroxyl groups with a polyisocyanate to form an elastomer.

Preferred monomer combinations are at least one of lower alkyl esters (of from about 1 to 3 carbon atoms) of malonic acid, succinic acid, glutaric acid, adipic acid, pimelic acid, suberic acid, azelaic acid, sebacic acid, undecanedioic acid, dodecanedioic acid, brassylic acid; and glycerol, pentaerythritol or xylitol. Most preferably, the reactants are glycerol and dimethyl esters of azelaic, adipic, sebacic or undecanoic acid.

The monomers molar ratio when using one polyol and one alkyl ester of a polycarboxylic acid are preferably about 0.5:1 to about 1:0.5, and more preferably about 0.75:1 to about 1:0.75, and most preferably about 1:1. The molar ratio of the monomers can be adjusted in order to maximize or minimize the amount of residual hydroxyl or alkyl ester end groups in order to tailor the properties of the polyester polymer composition to specific applications. The molar ratio of monomers can also be adjusted to change the theoretical gel point of the reaction, in order to facilitate a more consistent polymerization process and mitigate the possibility of unintended batch gelation.

Comonomers are preferably introduced so as to be provided in amounts up to no greater than about 50 mole % of the overall total moles of the combined monomers, more preferably no greater than about 30 mole % of the overall total moles of the combined monomers, and still more preferably no greater than about 10 mole % of the overall total moles of the combined monomers.

Without intending to be limiting, examples of comonomers that may be used are polyols or alkylene polyols, preferably different from the polyol of the first monomer; cyclic esters; acrylates; methacrylates; alkyl acrylates; alkyl methacrylates; carboxylic acids; polycarboxylic acids; alkyl polyiisocyanates; and esters of polycarboxylic acids, preferably that are different than the second monomer. Such co-monomers may be functionalized using groups as noted above with respect to the first and second monomers if desired or to achieve specific desired end use properties, e.g., in a particular biocompatible and/or bioresorbable end application. Similar compounds to those noted herein may be used as co-monomers or combinations of these materials may be used, provided that the co-monomer(s) employed do not overly interfere with the formation of polymers noted herein, and that the resulting polymeric materials formed are preferably able to provide the desired biocompatible and/or bioresorbable properties.

The method may also then include introducing the comonomer so that it is provided in amounts that are in some embodiments not greater than about 30 mole % of the overall total moles of the monomers in the reaction mixture, or not greater than about 10 mole % of the overall total moles of the monomers in the reaction mixture. Such a method may also further comprise introducing the comonomer after the reaction between the first and second monomer has begun. In one preferred embodiment, the first monomer is glycerol, the second monomer is dimethyl sebacate and the comonomer is selected from the group of polylactic acid, caprolactone, ethylene glycol, propylene glycol, polypropylene glycol, polyethylene glycol, glycolic acid, hexamethylene diisocyanate, and methylene diisocyanate.

The process herein solves problems in the prior art methods for forming such materials as the alkyl esters of the polycarboxylic acids and polyols can be selected such that they are liquids at room temperature, or at a temperature below the chosen reaction temperature, so as to form a homogeneous mixture with agitation either prior to reaction and/or at least partially, or completely, simultaneously with the start of and continuing polymerization reaction, allowing the mixture to be heated rapidly to the intended reaction temperature, without having to wait for the monomers to dissolve as in the prior art, and without the drawback of significant portions of the reaction occurring before the mixture is homogeneous. Accordingly, the polyols and alkyl esters of the polycarboxylic acids chosen (as well as any further co-monomers) should be selected to both undergo a transesterification process between the polyol monomers and the monomers that are alkyl esters of polycarboxylic acids, but also so that they are liquids at room temperature (or at a temperature below the chosen reaction temperature), in order to homogeneously mix the monomers and initiate and continue reaction beginning or starting early into polymerization with a homogeneous mixture of monomers. Some co-monomers, other than the initial two monomer types, may be added later for modification of the polymers if desired and/or if they are not generally liquids at the same reaction temperature of the initial two monomer types.

As used herein, “homogenous” is intended to mean that the mixture is sufficiently well mixed while under agitation, with all monomers in the liquid phase, to facilitate uniform reaction of the comonomers to produce the polyester copolymers of the invention.

Another advantage of the method is that in preferred reactions herein, the byproducts are generally alkanols which are easier to boil off and remove from the reaction vessel than water, allowing for removal from the vessel at milder conditions than prior process. For example, the byproduct of the reaction of dimethyl sebacate, which boils at 65° C. is methanol. Generally, transesterification reactions can proceed at temperatures that are lower than those of esterification reactions for this reason. Additionally, the alkanol byproducts can generally be removed without the need for high vacuum equipment, as in the prior art esterification processes.

The preferred alkyl esters of polycarboxylic acids, and preferably the dialkyl esters of dicarboxylic acids noted above are used in cosmetics, pharmaceuticals and as plasticizers and so they generally have uses that are already considered non-toxic and/or are government approved for use, such as by the FDA for medical devices and the like.

Another advantage of the present method is the ability to control the reaction rate by allowing it to proceed at its own rate or to accelerate the reaction through use of a catalyst (such as an acid catalyst which donates a proton or hydrogen to a carbonyl group or a base catalyst which can remove a proton or hydrogen from an alcohol group. Other transesterification catalysts can include alkyl titanates or alkyl tin compounds. In preferred embodiments, alkyl metal oxides, or other catalysts approved by the FDA for medical use are employed. In a particularly preferred embodiment herein, using dimethyl sebacate and glycerol monomers, a preferred catalyst is dibutyltin oxide. Catalysts can be added in varying amounts depending on the catalyst chosen, the nature of the reactants, and the desired speed of the reaction.

Catalysts may be added in amounts of about 0.01 to about 1.5 weight percent of the total weight of the reactants in the reaction mixture, preferably about 0.01 to about 1.0 weight percent based on the total weight of the reactants in the reaction mixture. Lesser amounts are indicated when using an alkyl metal oxide catalyst.

The progress of the transesterification can be monitored by measuring polymer viscosity via a Cone & Plate Viscometer. The hydroxyl value of the polymer can also be measured and monitored using Fourier Transform Near-Infrared Spectroscopy (FT-NIR). Plotting of the viscosity versus the hydroxyl value yields a “glide path” curve for the polymerization. This aids in reproducibly synthesizing polymers with consistent properties from batch to batch and a narrower molecular weight distribution. The process noted enables a polymerization starting in a homogeneous reaction mixture or prepared partially or completely simultaneously with the formation of a homogeneous reaction mixture, without the need to add water, and without the need to reflux and subsequently remove water, thereby providing an efficient and economical process. Using the initial prior art process of U.S. Pat. No. 7,722,894, a process is described that requires application of high vacuum and a reaction time of 77 hours. In the process of U.S. Pat. No. 9,359,472, the patent describes a “water mediated polymerization,” that requires also application of a high vacuum and reaction times of over 75 hours. By contrast, a narrower molecular weight distribution polymer with consistent properties can be prepared in approximately 15-16% of the time of the prior art processes, i.e., greater than about 6 times faster without the need for high vacuum equipment.

The polymers formed from the method may be used to form a number of items including drug delivery devices, tissue adhesives, soft tissue replacements and tissue engineering structures, such as for use in cardiac muscle, blood, nerve, cartilage and retina tissue, hard tissue replacements and tissue engineering structures such as for use in bone, as medical devices and components thereof, in implants, as components for cosmetics and pharmaceuticals, and for use in industrial processes.

In a preferred embodiment, they are used to form particles for use in the invention described in U.S. Pat. No. 9,186,377, U.S and International Patent Publication No. WO 2019/050975 A1. Any acceptable technique may be used for producing the particles of the invention of the '377 patent and the '975 publication, using polymers and copolymers formed from the method herein, The particles can be formed using varying degrees of crosslinking of prepolymers and subsequently enhancing crosslinking through post-curing or further heat processing to yield a desired final elastomeric form and can be formed by extrusion, molding, or other forming process which may or may not require heat depending the curing reaction that is applicable to the system chosen.

Any suitable process may be used to form articles from the polymers and copolymers formed from the method herein, including heat forming processes, such as compressing molding, injection molding, extrusion and the like. Any other acceptable techniques may be used to form items as well. The particles in the noted patents may be produced by forming as noted above or may be formed using solvent-based processes such as double emulsion and solvent evaporation, freeze drying, spray drying, extrusion; cryoformation; or latex polymerization/separation. In the case of particles formed from the polyester polymers herein, such as PGS, the particles can be formed from uncrosslinked or only partially crosslinked prepolymers and subsequently further crosslinked to yield a final form with a desired degree of crosslinking and/or polymerization.

In one preferred embodiment, the bulk and/or surface of the particles can be further modified by various functional groups and/or by incorporating bio-lubricious compounds either into formation of the particles or through functionalizing or copolymerizing polymers formed according to the processes herein with groups or monomers or other suitable polymers to provide or otherwise incorporate lubricin or hyaluronic acid either in small molecule form on the polymer backbone, as a copolymer monomer or as an additive worked into the polymer after or during formation, particularly on the particle surface through surface modification techniques as are known in the art.

The presence of bio-lubricious compounds on the surface of the particles may enhance frictional properties, resulting in improved movement within a joint and mitigate impingement. The presence of bio-lubricious compounds in the bulk of the particles, in the case of surface eroding materials such as PGS, can also provide replenishment of the bio-lubricious compounds as the particle degrades.

One method of incorporating the bio-lubricious compound into the particles is via grafting or other surface modification. Difunctional compounds, such as those used to crosslink bio-compatible hydrogels, can be used to connect bio-lubricious compounds to particles via reaction with functional groups present on the bio-lubricious compounds and on the polymers the particles are formed from. For example, both hyaluronic acid and the chondroitin sulfate moieties present on the terminal segments of lubricin contain hydroxyl and carboxylic acid groups that can be useful for grafting the molecules onto polymers useful for forming the particles of the invention. PGS prepared by prior art esterification methods, for example, being a polyester, also contains hydroxyl and carboxylic acid end groups that can be exploited for the purpose of grafting reactions. PGS prepared by the process of the invention described herein is a polyester that contains hydroxyl and alkyl ester groups that can be similarly exploited. Specific difunctional grafting agents include, but are not limited to glutaraldehyde, divinyl sulfone, adipic acid dihydrazide and butanediol diglycidyl ether.

The monomers used for forming the polymers according to the process herein may also include in a functionalized monomer or monomers preferred functional groups for receiving and reacting with lubricin, hyaluronic acid or the like for forming a copolymer having lubricin or hyaluronic acid bonded on various locations to a base polymer chain prior to particle formation and/or simply mixing such agents into the bulk of the monomers and reaction mixture during or prior to formation of the polymers or before formation of the particles themselves (such as through a latex or solvent reaction).

Another method of incorporating the bio-lubricious compound into the particles involves swelling the particles with a solution containing the bio-lubricious compound. Optionally, the solvent could subsequently be removed via evaporation to leave behind the bio-lubricious compound.

In another embodiment, a particle used herein may contain one or more of the resorbable, biocompatible materials described above and formed by the process herein, and be coated with the same or a different resorbable, biocompatible material. For example, a particle of poly(L-lactide-co-caprolactone), PGS, PGSL or another resorbable and/or biocompatible material can be formed with a coating, for example, an elastomeric PGS coating, to achieve varying properties for different resorbance periods or different physical properties. A method of coating a particle with PGS is described for example in U.S. Patent Publication No. 2016/0251540 A1, incorporated herein in relevant part.

The particles formed by the process herein may be used in treatment compositions including the particles and a carrier fluid. The carrier fluid may include, but is not limited to, aqueous solutions including physiologic electrolyte or ionic solutions such as saline solution or lactated ringer's solution, chondroitin sulfate, synovial fluid, viscosupplemental fluid such as hyaluronic acid commercially available as ORTHOVISC® produced by DePuy Ortho Biotech Products of Raritan, New Jersey, and combinations thereof. The composition may also include at least one therapeutic agent for treating osteoarthritis or other disease affecting the joints. The therapeutic agent may include hyaluronic acid, modified hyaluronic acid, anti-inflammatory medication such as steroids, non-steroidal anti-inflammatory agents, numbing agents such as lidocaine or the like.

The invention will now be further explained with reference to the following non-limiting examples.

### Example 1

Synthesis of Poly (Glycerol Sebacate)

A 500 ml, 4-necked reaction flask was equipped with a heating mantle, an agitator shaft, a thermocouple, a nitrogen sparge tube and a Dean-Stark trap with a reflux condenser, after which, exposed areas of glass were wrapped with insulation. The reaction flask was charged with a 1:1 molar ratio of glycerol, 102.3 grams, and dimethyl sebacate, 255.9 grams, in addition to 0.3 grams of dibutyltin oxide. The reaction mixture was heated with nitrogen sparge and agitation to a temperature of 180° C. over the course of 0.25 hours. The temperature was maintained in the range of 180-182° C., at ambient pressure, with nitrogen sparge and agitation for an additional 13 hours, during which time 50.7 grams of condensate was collected.

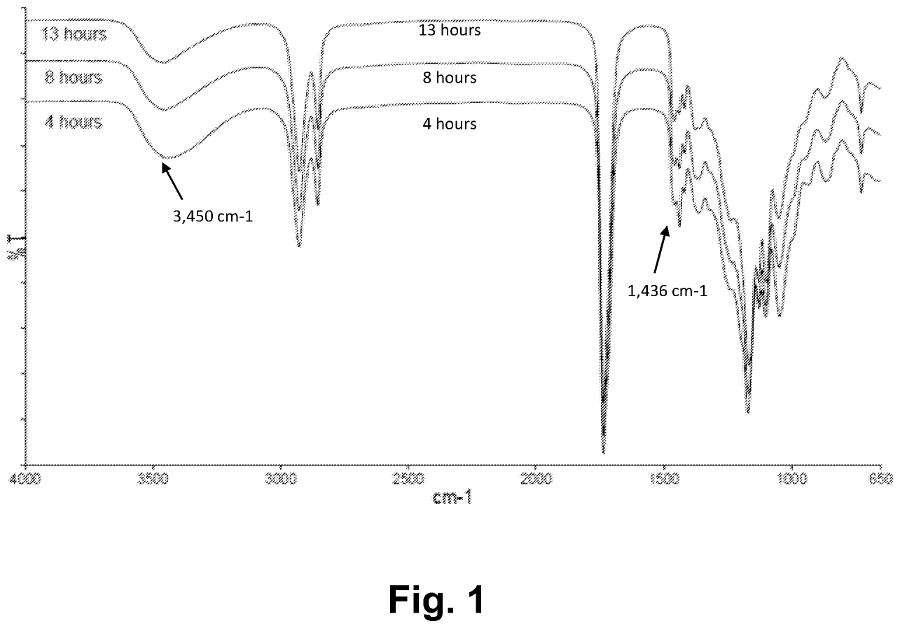

Progress of the polymerization was monitored by periodically removing samples, which were subsequently analyzed for viscosity and hydroxyl value. Progress of the polymerization was also monitored by analyzing the samples via Fourier Transform Infrared Spectroscopy (FTIR), using the Attenuated Total Reflectance (ATR) method, and observing the reduction in size of characteristic peaks for —OH (3,450 cm⁻¹) and —OCH 3 (1,436 cm⁻¹). The progress of the reaction is illustrated by an overlay of the FTIR spectra over the course of the reaction, given in FIG. 1. The reaction was run all the way to the gel point, after which, the reaction mixture was cooled to 100° C. and the resulting PGS polymer product was isolated.

The reaction yielded 235.4 grams of PGS polymer product in the form of a light tan colored elastomeric gel. The final sample taken just prior to gelation was analyzed and found to have a viscosity of 369.0 poise at 50° C., via Cone & Plate Viscometer, a hydroxyl number of 289.1 (mg KOH/g), via FT-NIR, and an acid number of 6.11 (mg KOH/g).

The viscosity and hydroxyl number values of the in-process samples are summarized in Table 1: Example 1 Viscosity and OH #Data.

TABLE 1

| | | C&P Visc. | FT-NIR OH# |
|---|---|---|---|
| Sample# | Time (hr) | (50° C., poise) | (mg KOH/g) |
| 1 | 4.00 | 0.5 | 363.2 |
| 2 | 6.00 | 2.5 | 334.4 |
| 3 | 8.00 | 6.0 | 316.9 |
| 4 | 10.00 | 15.5 | 305.9 |
| 5 | 12.00 | 55.5 | 296.1 |
| 6 | 13.00 | 369.0 | 289.1 |

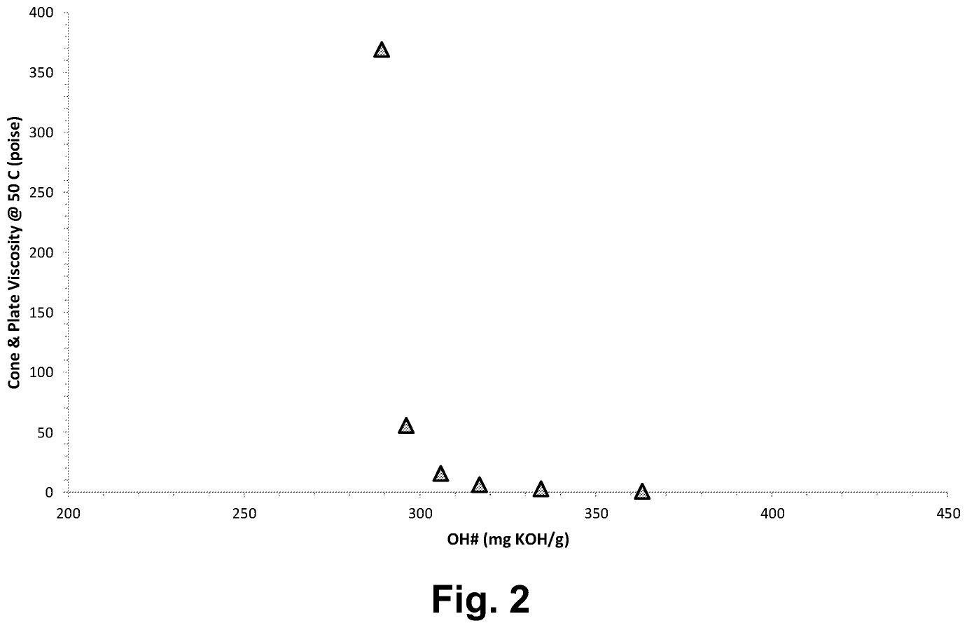

The viscosity values were plotted versus the corresponding hydroxyl values and the “glide path” curve was determined as shown in FIG. 2.

Several of the in-process samples were analyzed via Gel Permeation Chromatography (GPC) using a TOSOH Ecosec instrument with 2 TSkgel GMH_{HR}-M(S) 7.8 mm I.D.×30 cm columns and an RI detector versus polystyrene standards using THF as the solvent at a flow rate of 1 ml/min at a temperature of 40° C. The weight average molecular weight (M w) and Polydispersity Index (M_{w}/Mₙ) data obtained is summarized in Table 2: Example 1 GPC Data.

TABLE 2

| | | Molecular | Polydispersity |
|---|---|---|---|
| | | Weight (M_{w}) | Index |
| Sample# | Time (hr) | (Daltons) | (M_{w}/Mₙ) |
| 1 | 8.00 | 2,867 | 2.132 |
| 2 | 10.00 | 5,495 | 3.051 |
| 3 | 12.00 | 14,611 | 5.881 |

The reaction in Example 1 was run all the way to the point of gelation in only about 13 hours at ambient pressure, when compared to the prior art processes which took about 75-77 hours and high vacuum equipment to reach final conversions short of gelation, representing a significant improvement over the prior art.

### Example 2

Synthesis of Poly (Glycerol Sebacate)

A 500 ml, 4-necked reaction flask was equipped with a heating mantle, an agitator shaft, a thermocouple, a nitrogen sparge tube and a Dean-Stark trap with a reflux condenser, after which, exposed areas of glass were wrapped with insulation. The reaction flask was charged with a 1:1 molar ratio of glycerol, 102.3 grams, and dimethyl sebacate, 255.9 grams, in addition to 0.3 grams of dibutyltin oxide. The reaction mixture was gradually heated with nitrogen sparge and agitation to a temperature of 180° C. over the course of 0.5 hours. The temperature was maintained in the range of 180-182° C., at ambient pressure, with nitrogen sparge and agitation for an additional 11.5 hours, during which time 56.4 grams of condensate was collected.

Progress of the polymerization was monitored by periodically removing samples, which were subsequently analyzed for viscosity and hydroxyl value. Upon observation of a rapid increase in viscosity, the reaction mixture was cooled to 100° C. and the resulting liquid PGS prepolymer product was isolated.

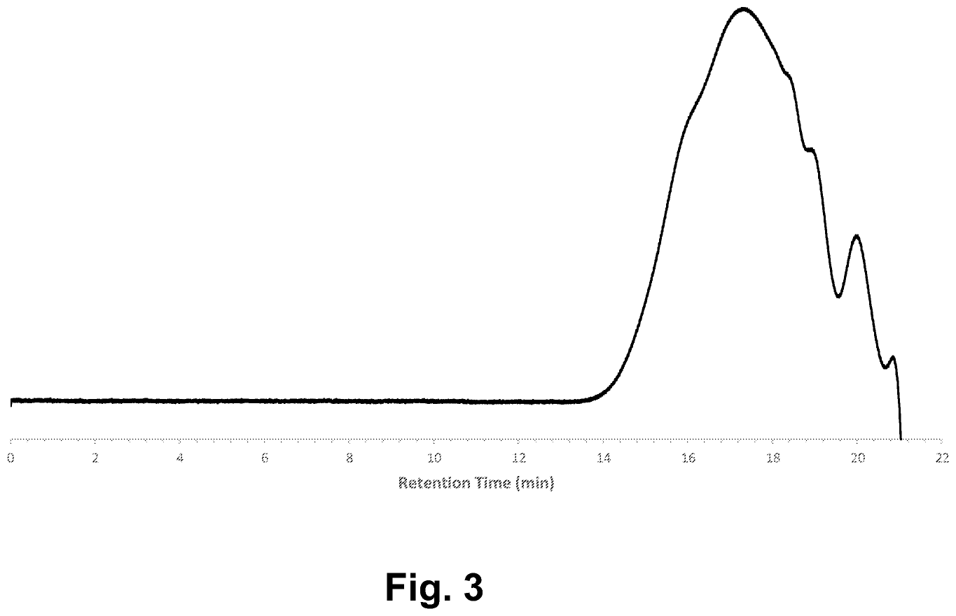

The reaction yielded 266.7 grams of PGS prepolymer product in the form of a light tan colored liquid. The PGS prepolymer product was analyzed and found to have a viscosity of 34.5 poise at 50° C., via Cone & Plate Viscometer, a hydroxyl number of 268.8 (mg KOH/g), via FT-NIR, an acid number of 2.46 (mg KOH/g) and a weight average molecular weight (M w) of 8,273 Daltons and Polydispersity Index of 3.898, via GPC. The GPC chromatogram of the PGS product is given in FIG. 3. The chromatogram exhibits a more uniform molecular weight distribution than chromatograms provided of PGS polymers produced via prior art methods in the corresponding patents, which often appear to be polymodal, such as the chromatograms given in FIG. 6 of the '472 patent. Additionally, the Polydispersity Index values obtained from the samples analyzed indicate PGS polymers with narrower molecular weight distributions than those obtained via the prior art methods.

The process reaction in the example was stopped when the viscosity started to increase rapidly to yield the liquid prepolymer product in only about 12 hours at ambient pressure, when compared to the prior art processes which took about 75-77 hours and high vacuum equipment to reach final conversions representing a significant improvement over the prior art.

### Example 3

Thermal Cure of PGS

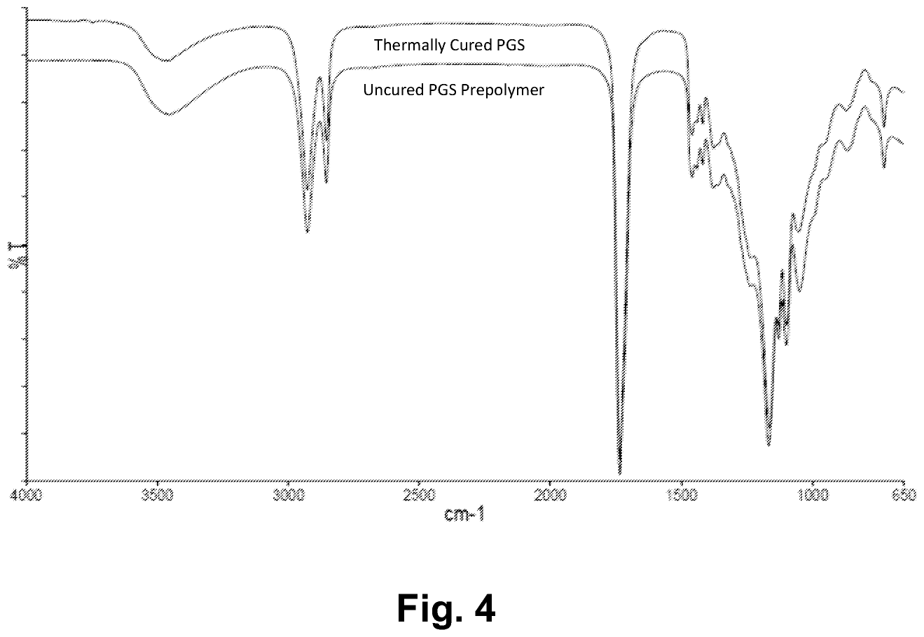

Samples of the liquid prepolymer prepared in Example 2 were subsequently thermally cured at ambient pressure and 120° C. for 48 hours to give elastomeric sheets with properties suitable for making particles for use in the invention of U.S. Pat. No. 9,186,377, U.S and International Patent Publication No. WO 2019/050975 A1. The samples exhibited an average weight loss of approximately 6.5% as a result of the evolution of methanol during the curing reaction. The progress of the curing reaction is illustrated by an overlay of the FTIR spectra of the uncured PGS prepolymer and the cured PGS elastomer, given in FIG. 4. The resulting cured sheets, with a thickness of approximately 1.5 mm, were placed in a freezer overnight. A circular die with a diameter of 1.5 mm was then used to cut cylindrical beads from the frozen sheets that were about 1.5 mm in diameter and 1.5 mm in height.

### Example 4

Thermal Cure of PGS

The PGS prepolymer of Example 2 was injected into an aluminum mold and subsequently thermally cured at ambient pressure and 120° C. for 48 hours to give spherical beads with a diameter of approximately 4 mm.

### Example 5

Isocyanate Cure of PGS

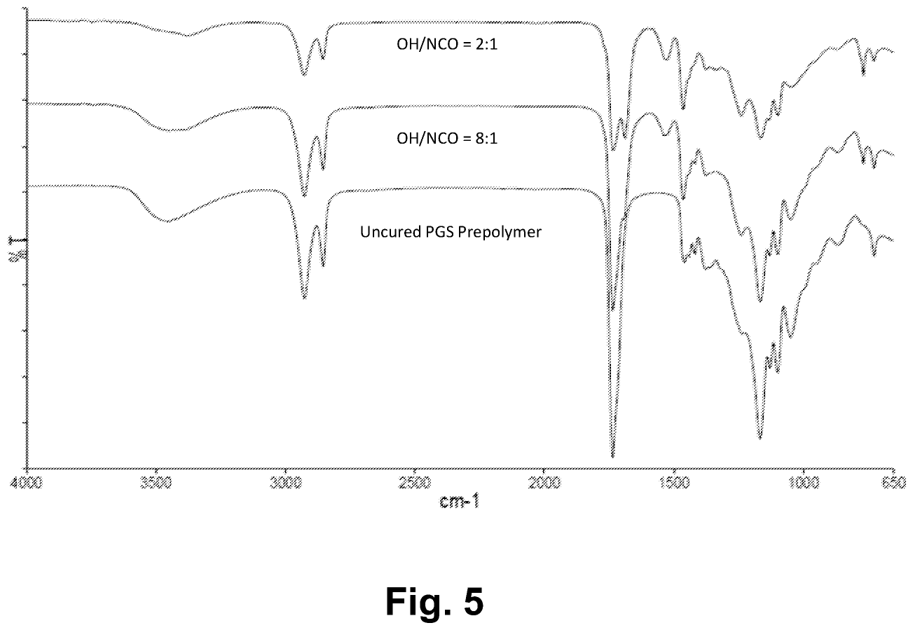

Samples of the PGS prepolymer of Example 2 were mixed with a hexamethylene diisocyanate trimer, available as Tolonate™ HDT-LV2 from Vencorex Chemicals, in hydroxyl to isocyanate (OH/NCO) ratios of 1.05:1, 2:1, 3:1, 4:1, 5:1, 6:1, 8:1 and 10:1 and subsequently cured at ambient pressure and 70° C. for 1 hour. The progress of the curing reaction is illustrated by an overlay of the FTIR spectra of the uncured PGS prepolymer and representative isocyanate cured PGS elastomers, given in FIG. 5. The complete reaction of the isocyanate is indicated by the absence of the characteristic peak for the NCO stretch at 2,260 cm⁻¹ in the FTIR spectra of the cured samples. Ratios of OH/NCO in the range of 6:1 to 8:1 were found to yield cured elastomers with properties suitable for making particles for use in the invention of U.S. Pat. No. 9,186,377, U.S and International Patent Publication No. WO 2019/050975 A1.

### Example 6

Isocyanate Cure of PGS

The PGS prepolymer of Example 2 was thoroughly mixed with Tolonate™ HDT-LV2 in a OH/NCO ratio of 8:1. The resulting mixture was injected into an aluminum mold and subsequently cured at ambient pressure and 70° C. for 1 hour to give spherical beads with a diameter of approximately 4 mm.

### Example 7

Synthesis of Poly (Glycerol Sebacate)

A 500 ml, 4-necked reaction flask was equipped with a heating mantle, an agitator shaft, a thermocouple, a nitrogen sparge tube and a Dean-Stark trap with a reflux condenser, after which, exposed areas of glass were wrapped with insulation. The reaction flask was charged with a 1:1 molar ratio of glycerol, 102.3 grams, and dimethyl sebacate, 255.9 grams, in addition to 0.3 grams of dibutyltin oxide. The reaction mixture was gradually heated with nitrogen sparge and agitation to a temperature of 140° C. over the course of 1 hour. The temperature was maintained in the range of 140-142° C., at ambient pressure, with nitrogen sparge and agitation for an additional 46 hours, during which time 30.1 grams of condensate was collected.

Progress of the polymerization was monitored by periodically removing samples, which were subsequently analyzed for viscosity and hydroxyl value. Upon observation of a rapid increase in viscosity, the reaction mixture was cooled to 100° C. and the resulting liquid PGS prepolymer product was isolated.

The reaction yielded 245.4 grams of PGS prepolymer product in the form of a light tan colored liquid. The PGS prepolymer product was analyzed and found to have a viscosity of 38.0 poise at 50° C., via Cone & Plate Viscometer, a hydroxyl number of 292.1 (mg KOH/g), via FT-NIR, and an acid number of 2.15 (mg KOH/g).

The process reaction in the example was stopped when the viscosity started to increase rapidly to yield the liquid prepolymer product in only about 46 hours at ambient pressure, when compared to the prior art processes which took about 75-77 hours and high vacuum equipment to reach final conversions representing a significant improvement over the prior art.

### Example 8

Synthesis of Poly (Glycerol Adipate)

A 500 ml, 4-necked reaction flask was equipped with a heating mantle, an agitator shaft, a thermocouple, a nitrogen sparge tube and a Dean-Stark trap with a reflux condenser, after which, exposed areas of glass were wrapped with insulation. The reaction flask was charged with a 1:1 molar ratio of glycerol, 128.3 grams, and dimethyl adipate, 243.6 grams, in addition to 1.5 grams of a 1.0 Normal KOH solution in methanol. The reaction mixture was gradually heated with nitrogen sparge and agitation to a temperature of 140° C. and the temperature was maintained in the range of 140-142° C., at ambient pressure, with nitrogen sparge and agitation for an additional 27.5 hours, during which time 20.2 grams of condensate was collected.

Progress of the polymerization was monitored by periodically removing samples, which were subsequently analyzed for viscosity and hydroxyl value. Upon observation of a rapid increase in viscosity, the reaction mixture was cooled to 100° C. and the resulting liquid Poly (glycerol adipate), or PGA, prepolymer product was isolated.

The reaction yielded 250.3 grams of PGA prepolymer product in the form of a light brown colored liquid. The PGA prepolymer product was analyzed and found to have a viscosity of 45.5 poise at 50° C., via Cone & Plate Viscometer, a hydroxyl number of 346.2 (mg KOH/g), via FT-NIR, and an acid number of 0.45 (mg KOH/g).

The process reaction in the example was stopped when the viscosity started to increase rapidly to yield the liquid prepolymer product in only about 28 hours at ambient pressure, when compared to the prior art processes which took about 75-77 hours and high vacuum equipment to reach final conversions representing a significant improvement over the prior art.

### Example 9

Synthesis of Poly (Glycerol Sebacate)

A 500 ml, 4-necked reaction flask was equipped with a heating mantle, an agitator shaft, a thermocouple, a nitrogen sparge tube and a Dean-Stark trap with a reflux condenser, after which, exposed areas of glass were wrapped with insulation. The reaction flask was charged with a 1:0.78 molar ratio of glycerol, 124.6 grams, and dimethyl sebacate, 243.2 grams, in addition to 0.3 grams of dibutyltin oxide. The reaction mixture was heated with nitrogen sparge and agitation to a temperature of 180° C. over the course of 0.25 hours. The temperature was maintained in the range of 180-182° C., at ambient pressure, with nitrogen sparge and agitation for an additional 12.5 hours, during which time 51.4 grams of condensate was collected.

Progress of the polymerization was monitored by periodically removing samples, which were subsequently analyzed for viscosity and hydroxyl value. Upon observation of a rapid increase in viscosity, the reaction mixture was cooled to 100° C. and the resulting liquid PGS prepolymer product was isolated.

The reaction yielded 237.6 grams of PGS prepolymer product in the form of a light tan colored liquid. The PGS prepolymer product was analyzed and found to have a viscosity of 84.0 poise at 50° C., via Cone & Plate Viscometer, a hydroxyl number of 295.8 (mg KOH/g), via FT-NIR, and an acid number of 3.94 (mg KOH/g).

The process reaction in the example was stopped when the viscosity started to increase rapidly to yield the liquid prepolymer product in only about 13 hours at ambient pressure, when compared to the prior art processes which took about 75-77 hours and high vacuum equipment to reach final conversions representing a significant improvement over the prior art.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

We claim:

1. A method for forming a polymer, comprising:
providing a first monomer comprising a polyol having at least two hydroxyl groups;
providing a second monomer comprising a polyalkyl ester of a polycarboxylic acid having at least two alkyl ester groups;
mixing the first monomer and the second monomer to form a reaction mixture;
and reacting the first monomer and the second monomer in the mixture by transesterification to form a polyester polymer.

2. The method according to claim 1, wherein the first monomer is a diol or a triol.

3. The method according to claim 2, wherein the first monomer is a triol.

4. The method according to claim 2, wherein the first monomer is selected from the group consisting of glycerol, pentaerythritol, and xylitol.

5. The method according to claim 4, wherein the first monomer is glycerol.

6. The method according to claim 1, wherein the second monomer is a dialkyl ester of a dicarboxylic acid of from 2 to about 30 carbon atoms.

7. The method according to claim 1, wherein the dialkyl dicarboxylic acid ester is a dialkyl ester of a dicarboxylic acid selected from the group consisting of oxalic acid, malonic acid, succinic acid, glutaric acid, adipic acid, pimelic acid, suberic acid, azelaic acid, sebacic acid, undecanedioic acid, dodecanedioic acid, brassylic acid, thapsic acid, japanic acid, phellogenic acid, and equisetolic acid.

8. The method according to claim 1, wherein the first monomer is glycerol, the second monomer is dimethyl sebacate and the polymer is poly(glycerol sebacate).

9. The method according to claim 1, wherein the molar ratio of the first monomer to the second monomer is about 0.5:1 to about 1:0.5.

10. The method according to claim 9, wherein the molar ratio of the first monomer to the second monomer is about 0.75:1 to about 1:0.75.

11. The method according to claim 10, wherein the molar ratio of the first monomer to the second monomer is about 1:1.

12. The method according to claim 1, wherein the transesterification reaction occurs at a temperature wherein the first and the second monomers are a liquid for forming a homogeneous mixture of the first monomer and the second monomer during the transesterification reaction.

13. The method according to claim 11, wherein the reaction mixture further includes a transesterification reaction catalyst selected from an acid catalyst, a base catalyst, an alkyl titanate catalyst or an alkyl tin catalyst.

14. The method according to claim 13, wherein the catalyst is a dibutyl tin oxide.

15. The method according to claim 1, wherein a transesterification reaction byproduct is an alkanol.

16. The method according to claim 1, wherein viscosity and hydroxyl value of a reaction mixture of the first monomer and the second monomer are monitored to determine the progress of the transesterification reaction.

17. The method according to claim 1, wherein the transesterification reaction is terminated as a prepolymer, and the method further comprises post-curing or further polymerizing the prepolymer through a heat process to form the crosslinked polyester polymer.

18. The method according to claim 1, wherein the transesterification reaction is terminated as a prepolymer, and the method further comprises post-curing or further reaction of the prepolymer with a crosslinking agent to form the crosslinked polyester polymer.

19. The method according to claim 18, wherein the crosslinking agent is a polyisocyanate.

20. The method according to claim 1, wherein the mixture is formed before onset of the reaction.

21. The method according to claim 1, wherein the mixture is formed at least partially simultaneously with the onset of the reaction.

22. The method according to claim 1, wherein the polymer formed has elastomeric properties.

23. The method according to claim 1, wherein the polymer formed is biocompatible, bioresorbable or both biocompatible and bioresorbable.

24. A polymer formed by the method of claim 1.

25. The polymer according to claim 24, wherein the polyester polymer is poly(glycerol sebacate).

26. An article formed from the polymer of claim 24.

27. The article of claim 26, wherein the article is biocompatible, bioresorbable or both biocompatible and bioresorbable.

28. The article according to claim 27, wherein the article is selected from the group of a polymer sheet, a drug delivery device, a mammalian tissue adhesive, a soft tissue replacement, a hard tissue replacement, a tissue engineering lattice, a medical device or a component thereof, and a particle for treatment of a mammalian joint.

29. The article of claim 28, wherein the particle is for treatment of an arthritic mammalian joint.

30. The method according to claim 1, further comprising introducing at least one co-monomer for forming a copolymer.

31. The method according to claim 30, wherein the at least one comonomer comprises one or more monomers selected from the group of a polyol or alkylene polyol, each being different from the polyol of the first monomer; a cyclic ester; an acrylate; a methacrylate; an alkyl acrylate; an alkyl methacrylate; a carboxylic acid; a polycarboxylic acid; an alkyl polyisocyanate; and an ester of a polycarboxylic acid that is different than the second monomer.

32. The method according to claim 30, further comprising introducing the comonomer in an amount not greater than about 30 mole %, based on the total moles of the monomers in the reaction mixture.

33. The method according to claim 32, further comprising introducing the comonomer in an amount not greater than about 10 mole % based on the total moles of the monomers in the reaction mixture.

34. The method according to claim 30, further comprising introducing the comonomer after the reaction between the first and second monomer has begun.

35. The method according to claim 30, wherein the first monomer is glycerol, the second monomer is dimethyl sebacate and the comonomer is selected from the group of polylactic acid, caprolactone, ethylene glycol, polyethylene glycol, propylene glycol, polypropylene glycol, glycolic acid, hexamethylene diisocyanate, and methylene diisocyanate.

36. A copolymer formed from the method of claim 30.

37. The copolymer of claim 36, wherein the copolymer is a poly(glycerol sebacate)-co-poly(lactic acid).

38. An article formed from the copolymer of claim 36.

39. The article of claim 38, wherein the article is biocompatible, bioresorbable or both biocompatible and bioresorbable.

40. The article according to claim 39, wherein the article is selected from the group of a polymer sheet, a drug delivery device, a mammalian tissue adhesive, a soft tissue replacement, a hard tissue replacement, a tissue engineering lattice, a medical device or a component thereof, and a particle for treatment of a mammalian joint.

41. The article of claim 40, wherein the particle is for treatment of an arthritic mammalian joint.
